(19) United States
(12) Patent Application Publication
(10) Pub. No.: US 2026/0352904 A1
(43) Pub. Date: Nov. 5, 2026

(54) TECHNIQUES FOR SERVICING LARGE VOLUMES OF REQUESTS WHEN STREAMING MEDIA TITLES

(71) Applicant: NETFLIX, INC., Los Gatos, CA (US)

(72) Inventor: Xiaomei LIU, Cupertino, CA (US)

(21) Appl. No.: 19/198,983

(22) Filed: May 5, 2025

(51) Int. Cl. H04N 21/239; H04N 21/2187; H04N 21/231; H04N 21/235

(52) U.S. Cl. CPC H04N 21/2393; H04N 21/2187; H04N 21/23106; H04N 21/235

(57) ABSTRACT

In various embodiments, a computer-implemented method for servicing requests for audiovisual content when streaming media titles includes receiving a first request for a first segment of audiovisual content associated with a media title, determining that a content database does not store the first segment of audiovisual content based on an inspection of a cache, and generating a first response to the first request indicating that the first segment of audiovisual content is unavailable.

### BACKGROUND

### Field of the Various Embodiments

Embodiments of the present disclosure relate generally to computer science and video processing and, more specifically, to techniques for servicing large volumes of requests when streaming media titles.

### Description of the Related Art

Modern streaming services typically implement cloud-based networks of computer systems to stream audiovisual content associated with media titles to endpoint devices. An architecture of a given cloud-based network often includes one or more content servers, one or more encoding pipelines, one or more packagers, one or more origin servers, and a content delivery network (CDN). In such an architecture, the content servers store audiovisual content and distribute that content to the encoding pipelines. The encoding pipelines encode the audiovisual content into a compressed format and transmit encoded audiovisual content to the packagers. The packagers prepare the encoded audiovisual content for playback on various downstream endpoint devices and provide the packaged audiovisual content to the origin servers. The origin servers store the packaged audiovisual content and distribute that content to the CDN. The CDN includes a hierarchy of geographically distributed nodes that distribute the content to nearby endpoint devices. A given endpoint device can decode the received audiovisual content and then output the decoded audiovisual content for display to a user.

When streaming a given media title, an endpoint device periodically requests discrete segments of audiovisual content from the CDN. The CDN typically responds to such requests by finding the requested segments of audiovisual content and sending the requested segments downstream to the requesting endpoint devices. Alternatively, if a requested segment of audiovisual content cannot be located, then the CDN issues a request to the upstream origin servers for the missing segment of audiovisual content. The origin servers, in response, access a content database in order to retrieve the requested segment of audiovisual content.

One drawback of the above approach is that occasionally a large number of endpoint devices issue a large number of requests over a very short time interval for specific segments of audiovisual content that the CDN cannot locate, causing the CDN to flood the origin servers with requests for the missing segments of audiovisual content. The origin servers, in turn, issue a large number of requests to the content database, potentially overwhelming the content database. As a result, the performance of the origin servers can become compromised, thereby degrading overall streaming performance.

As the foregoing illustrates, what is needed in the art is a more effective technique for servicing large volumes of requests during streaming.

### SUMMARY

In various embodiments, a computer-implemented method for servicing requests for audiovisual content when streaming media titles includes receiving a first request for a first segment of audiovisual content associated with a media title, determining that a content database does not store the first segment of audiovisual content based on an inspection of a cache, and generating a first response to the first request indicating that the first segment of audiovisual content is unavailable.

At least one technical advantage of the disclosed techniques relative to the prior art is that the origin server can service large volumes of requests for segments of audiovisual content that may not exist within the content database, without needing to issue correspondingly large volumes of requests to the content database. Accordingly, the disclosed techniques can be applied to protect the content database from a potentially overwhelming volume of requests, thereby helping to avoid performance degradations at the origin server. Another technical advantage of the disclosed techniques relative to the prior art is that the disclosed techniques can help mitigate timing asynchronies that can arise when segments of audiovisual content fall outside of a live edge timeout corresponding to a live event. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a more detailed block diagram of the content server of FIG. 1, according to various embodiments;

FIG. 3 is a more detailed block diagram of the control server of FIG. 1, according to various embodiments;

FIG. 4 is a more detailed block diagram of the endpoint device of FIG. 1, according to various embodiments;

FIG. 5 illustrates a network infrastructure that can be used to distribute audiovisual content to the endpoint devices of FIG. 1, according to various embodiments;

FIG. 6 illustrates how the origin servers of FIG. 5 service requests for missing segments of audiovisual content, according to various embodiments; and

FIG. 7 is a flow diagram of method steps for servicing requests for audiovisual content, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

Modern streaming services typically implement cloud-based networks of computer systems to stream audiovisual content associated with media titles to endpoint devices. In some configurations, when streaming audiovisual content associated with media titles, endpoint devices access discrete segments of the audiovisual content using a template-based approach. The template associated with a given media title typically describes various timing parameters of the segments of audiovisual content that allow the endpoint device to request specific segments from a CDN during the precise intervals of time when the specific segments are needed. The CDN responds to such requests by finding the requested segments of audiovisual content and sending the requested segments downstream to the requesting endpoint devices or issuing a request to upstream origin servers if the requested segment is not found.

One drawback of the above approach is that occasionally a large number of endpoint devices issue a large number of requests over a very short time interval for specific segments of audiovisual content that the CDN cannot locate, causing the CDN to flood the origin servers with requests for the missing segments of audiovisual content. In response, the performance of the origin servers and the underlying content database can become compromised, thereby degrading overall streaming performance.

As an example of the above scenario, when a large number of endpoint devices simultaneously stream a media title corresponding to an event that occurs in real time, the endpoint devices may frequently access the most recent segment of audiovisual content corresponding to a recent moment in time. If the endpoint devices rely on a faulty template in order to calculate when the most recent segment should be available, then the endpoint devices can inadvertently request a segment of audiovisual content that is no longer available or not yet available. Faulty templates can be distributed to endpoint devices due to encoder defects, among other causes. When such a scenario occurs, the origin servers can become overwhelmed with requests for segments of audiovisual data that are missing, unavailable, or otherwise cannot be found. In particular, the origin servers may issue many simultaneous queries to the content database, and the content database may be unable to respond to all such queries in a timely manner. The above issues can also occur due to client error, whereby the client performs template calculations incorrectly.

To address these issues, various embodiments include one or more origin servers configured to cache metadata associated with media titles being streamed. The metadata indicates timing information associated with the media title and/or one or more streams of encoded audiovisual content associated with the media title. When a given origin server receives a request for a segment of audiovisual content, before querying a content database to locate the segment, the origin server first inspects a cache and then determines, based on the metadata, whether the requested segment of metadata exists and has already been stored in the content database. If the origin server determines that the segment of audiovisual data does in fact reside in the content database, then the origin server fulfills the request. Otherwise, the origin server issues a response indicating that the requested segment is unavailable, without needing to issue any requests to the content database.

At least one technical advantage of the disclosed techniques relative to the prior art is that the origin server can service large volumes of requests for segments of audiovisual content that may not exist within the content database, without needing to issue correspondingly large volumes of requests to the content database. Accordingly, the disclosed techniques can be applied to protect the content database from a potentially overwhelming volume of requests, thereby helping to avoid performance degradations at the origin server. Another technical advantage of the disclosed techniques relative to the prior art is that the disclosed techniques can help mitigate timing asynchronies that can arise when segments of audiovisual content fall outside of a live edge timeout corresponding to a live event. These technical advantages provide one or more technological advancements over prior art approaches.

### System Overview

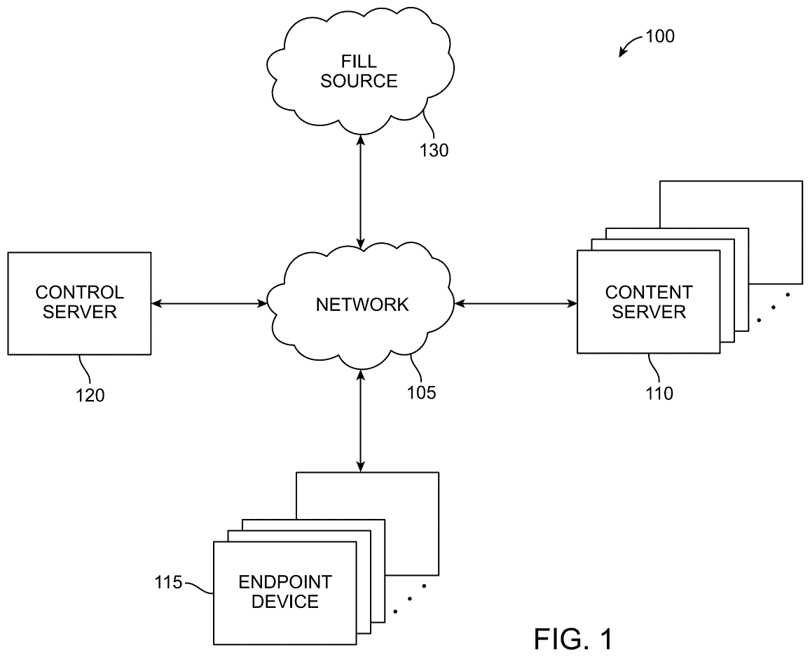

FIG. 1 illustrates a network infrastructure 100 used to distribute content to content servers 110 and endpoint devices 115, according to various embodiments. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, a database, and a server application configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

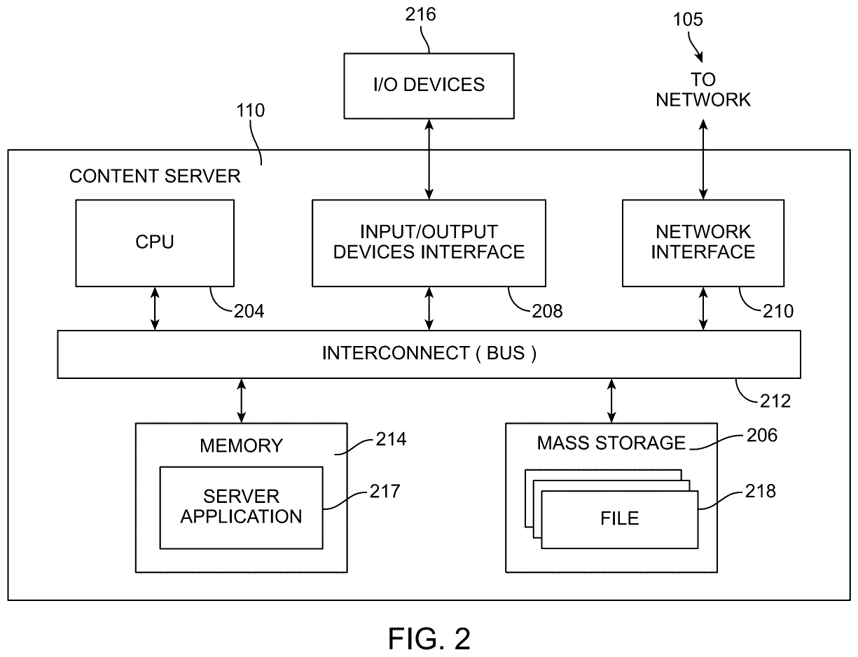

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a mass storage 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the mass storage 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The mass storage 206 may include one or more hard disk drives, solid state storage devices, or similar storage devices. The mass storage 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the mass storage 206 and transmits the file 218 to an endpoint device 115 or a content server 110 via the network 105.

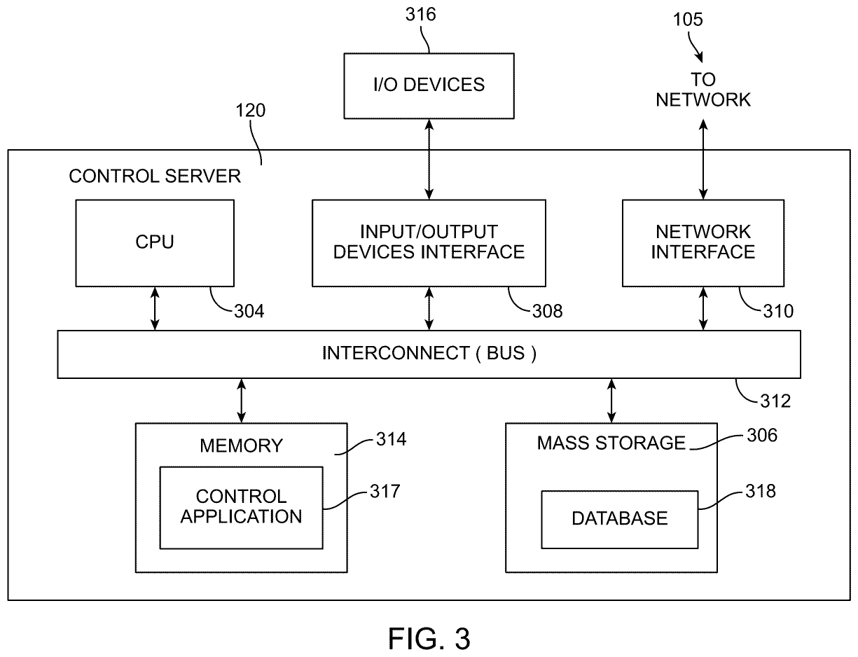

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a mass storage 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the mass storage 306. The interconnect 312 is configured to facilitate transmission of data between the CPU 304, the mass storage 306, I/O devices interface 308, the network interface 310, and the system memory 314. The I/O devices interface 308 is configured to transmit input data and output data between the I/O devices 316 and the CPU 304 via the interconnect 312. The mass storage 306 may include one or more hard disk drives, solid state storage devices, and the like. The mass storage 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

Referring generally to FIGS. 1-3, in various embodiments, the system 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline via control application 317 that compresses files 218 prior to transmission to an endpoint device 115. Alternatively, and without limitation, files stored in fill source 130 could be compressed, via an encoding pipeline within system 100, prior to storage.

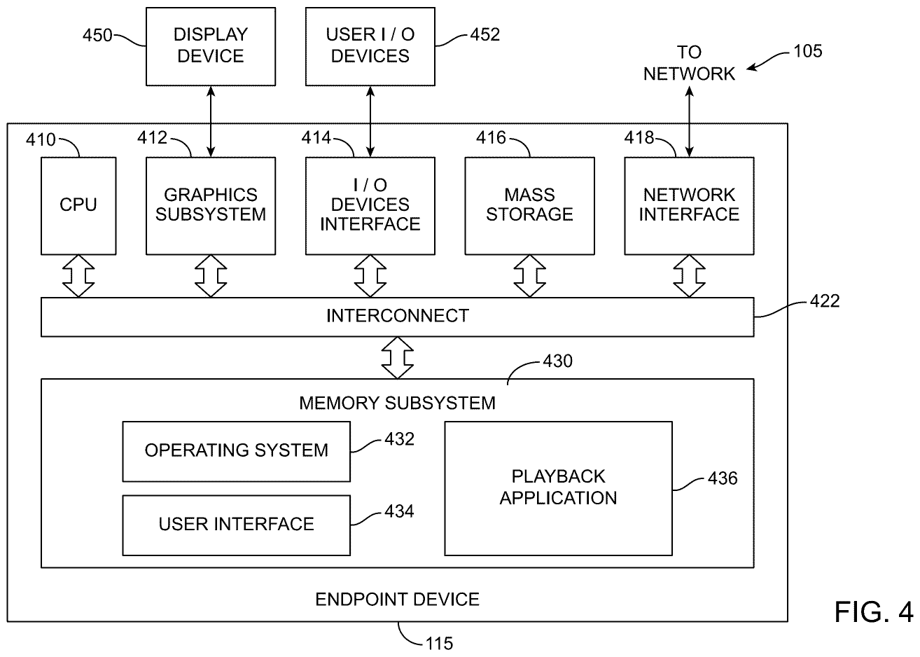

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well-known in the art and suitable for incorporation into the endpoint device 115.

In some embodiments, the playback application 436 is configured to request and receive content from the content server 110 via the network interface 418. Further, the playback application 436 is configured to interpret the content and present the content via display device 450 and/or user I/O devices 452. In one embodiment, the playback application 436 may include a decoding pipeline that decodes compressed content prior to display via display device.

Servicing Large Volumes of Requests when Streaming Media Titles

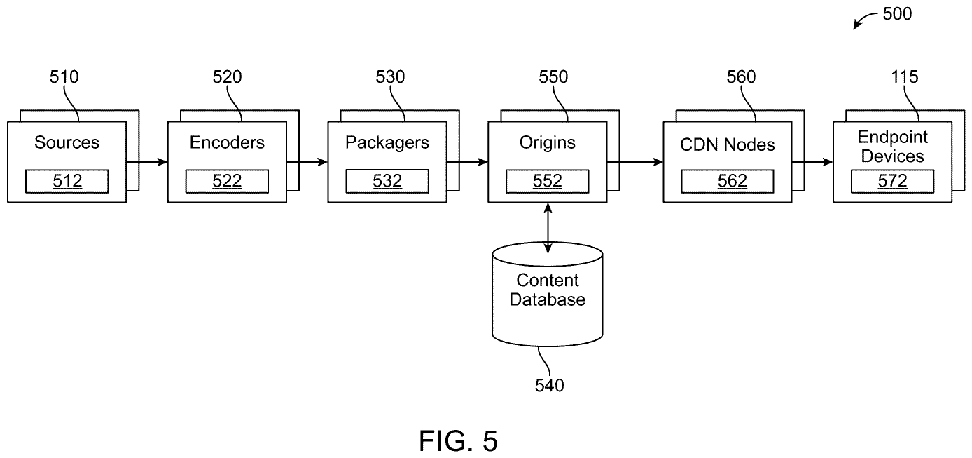

FIG. 5 illustrates a network infrastructure that can be used to distribute audiovisual content to the endpoint devices of FIG. 1, according to various embodiments. As shown, a network infrastructure 500 includes one or more sources 510, one or more encoders 520, one or more packagers 530, a content database 540, one or more origins 550, one or more content delivery network (CDN) nodes 560, and one or more endpoint devices 115. The network infrastructure 500 is configured to generate, process, and distribute segments of audiovisual content to endpoint devices 115, where a given segment of audiovisual content includes one or more frames of audiovisual data. In various embodiments, a segment may correspond to a two-second duration of audiovisual content.

The network infrastructure 500 may form any technically feasible portion of, or extension to, the network infrastructure 100 shown in FIG. 1. Further, various components of the network infrastructure 500 can be implemented via the different components of the network infrastructure 100 described above in conjunction with FIGS. 1-4. In particular, in various embodiments, origins 550 may be implemented via one or more fill sources 130 and/or CDN nodes 560 may be implemented via one or more content servers 110. Various components of the network infrastructure 100 and/or network infrastructure 500 may form a portion of a control plane, such as the control server 120, for example and without limitation, while other components of the network infrastructure 100 or network infrastructure 500 may form a portion of a data plane, such as the origins 530, for example and without limitation.

In operation, the sources 510 store raw frames 512 of audiovisual content corresponding to a library of different media titles. In one embodiment, the raw frames 512 may also be lightly compressed raw frames, among other options. The different media titles can be previously recorded, or, in some cases, correspond to live events that are occurring in real time. The sources 510 distribute the raw frames 512 of audiovisual content to the encoders 520. Upon receipt of the raw frames 512 of audiovisual content, the encoders 520 encode the raw frames of audiovisual content into encoded frames 522 of audiovisual content and provide the encoded frames 522 to the packagers 530 via one or more encoded video streams. The packagers 530 perform various packaging operations to prepare the encoded frames 522 for downstream decoding and output by endpoint devices 115, thereby generating packaged frames 532 of audiovisual content. As a general matter, the various frames of audiovisual content described herein correspond to different segments of a given media title, where a given segment includes one or more frames of audiovisual data.

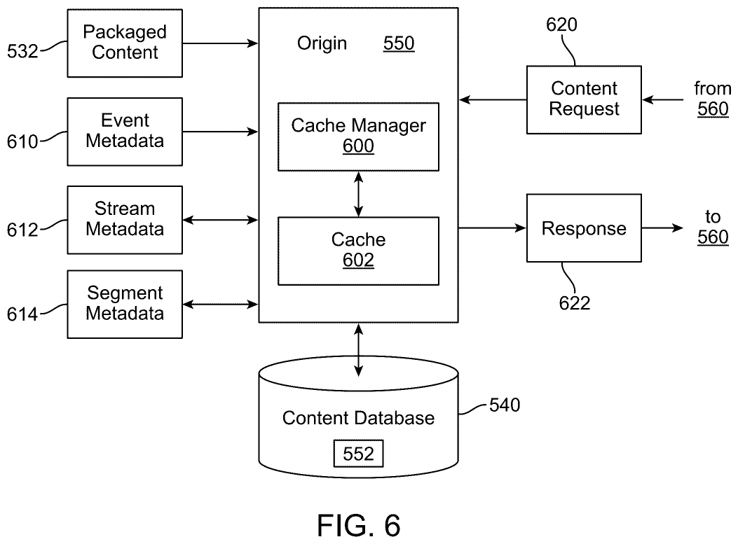

The packagers 530 transmit the packaged frames 532 to the origins 552, which provide storage of packaged frames 532 as compressed objects 552. In various embodiments, the origins 550 store the compressed objects 552 in a content database 540 that is shared between some or more of the origins 550. In one embodiment, the content database 540 may be a Cassandra database. As described in greater detail below in conjunction with FIG. 6, a given origin 550 is configured to cache metadata associated with media titles during streaming in order to reduce the number of requests that need to be serviced by the content database 540.

The origins 550 distribute the compressed objects 552 to the CDN nodes 562. The CDN nodes 562 are geographically distributed at edge locations proximate to different endpoint devices 115 and are configured to store cached objects 562 representing different copies of compressed objects 552. Upon request, one or more CDN nodes 562 transmit one or more cached objects 562 to endpoint devices 115 in order to support streaming media titles. A given endpoint device 115 performs a decoding operation with the received object(s) to generate decoded frames 572 of audiovisual content. Decoded frames 572 of audiovisual content can then be output to the user.

In various embodiments, multiple sources 510 are coupled to multiple downstream encoders 520, multiple encoders 520 are coupled to multiple downstream packagers 530, multiple packagers 530 are coupled to multiple downstream origins 550, multiple origins 550 are coupled to multiple downstream CDN nodes 560, and multiple CDN nodes 560 are coupled to multiple downstream endpoint devices 115, forming a distributed content generation and distribution system. In one embodiment, the network infrastructure 500 may process segments of audiovisual content having a fixed duration, such as two seconds, for example and without limitation. In this configuration, any given segment of audiovisual content may include portions of one or more video streams and/or portions of one or more audio streams that are processed by successive components of the network infrastructure 500.

Endpoint devices 115 can be configured to stream media titles using templates corresponding to the media titles. A given template corresponding to a given media title indicates timing information associated with segments of audiovisual content included in the media title and can be used by a given endpoint device 115 to request from a CDN node 560 specific segments of audiovisual content during precise intervals when the segments are needed. A template could include, for example and without limitation, a segment index corresponding to a first segment in the media title, a start time when the first segment is available, and a segment duration, among other possible timing parameters. Based on the timing information included in the template, an endpoint device 115 can compute the segment index of any given segment that is needed at any particular time during playback of the media title, and then request that segment from a CDN node 560. This technique can be applied when streaming live events so that endpoint devices 115 can access segments of audiovisual content corresponding to a current moment in time or a recent interval of time.

Under some conditions, however, endpoint devices 115 may analyze a given template and then request segments of audiovisual content that CDN nodes 560 cannot locate. For example, and without limitation, suppose encoders 520 suffer degraded performance and stop generating encoded frames 522 of audiovisual content. Subsequently, when a given endpoint device 115 attempts to access newer segments of audiovisual content based on the timing information included in the template, CDN nodes 560 would be unable to locate that audiovisual content because the content was never generated. Such situations can cause CDN nodes 560 to issue large volumes of requests to origins 550 in order to retrieve the missing audiovisual content, especially when streaming media titles corresponding to live events. Origins 550 implement a caching technique described below in conjunction with FIG. 6 in order to manage the potentially large volumes of such requests.

FIG. 6 illustrates how the origin servers of FIG. 5 service requests for missing segments of audiovisual content, according to various embodiments. As shown, origin 550 includes a cache manager 600 and a cache 602. Origin 550 is configured to receive packaged content 532 from packagers 530 and to store that content as compressed objects 552 in content database 540. In one embodiment, origin 550 may also implement an additional layer of storage for indexing the data stored in content database 540. Under nominal operating conditions, origin 500 is configured to receive a content request 620 from one or more CDN nodes 560 for a given segment of audiovisual content. In response, the origin 550 accesses one or more compressed objects 552 stored in content database 552 and then transmits a response 622 to the CDN node(s) that includes the compressed objects 552 corresponding to the requested audiovisual content. In one embodiment, response 622 may be a Hypertext Transfer Protocol (HTTP) response.

Origin 550 is also configured to receive and/or generate various metadata associated with one or more media titles being streamed. In various embodiments, the media titles may correspond to live events occurring in real time. As is shown, origin 550 receives event metadata 610, stream metadata 612, and segment metadata 614. In various embodiments, origin 550 may generate new version(s) or update existing version(s) of stream metadata 612 and/or segment metadata 614 in response to receiving one or more segments of audiovisual content from the packagers 530. Event metadata 610 includes timing parameters and/or other information associated with a given media title. Event metadata 610 may indicate an event configuration, including, for example and without limitation, an event identifier or a storage location for a media title corresponding to a live event. Event metadata 610 typically changes infrequently. Stream metadata 612 includes timing parameters associated with one or more streams of audiovisual content associated with a given media title. For example, and without limitation, stream metadata 612 could include a segment index and segment arrival time associated with a first segment of a media title, as well as a segment index and segment arrival time of a final segment of the media title. Stream metadata 612 typically changes infrequently. Segment metadata 614 includes per-segment data that generally changes frequently.

Cache manager 600 is configured to store event metadata 610 and stream metadata 612 within cache 602 when streaming media titles. Subsequently, in response to a content request 620 received from a CDN node 560, cache manager 600 can inspect cache 602 and determine whether the requested segment of audiovisual content resides in content database 540. If cache manager 600 determines based on cache 602 that a given segment of audiovisual content is not stored in content database 540, then origin 550 can respond to content request 620 (e.g. via an HTTP 404 or 410 response) without issuing any requests to content database 540. Under conditions where large volumes of content requests 620 arrive from CDN nodes 560 for segments of audiovisual content that could not be located within the CDN, the caching techniques described herein mitigate the impact on content database 540 and prevent content database 540 from being overwhelmed with requests. In one embodiment, cache 602 may be implemented as an in-memory cache by origin 550.

Cache manager 600 can determine that a given segment of audiovisual content is not stored in content database 540 using any technically feasible analysis of event metadata 610 and/or stream metadata 612. For example, and without limitation, suppose origin 550 receives a content request 620 for a segment of audiovisual content associated with a live event that does not exist. This situation could occur due to encoder defects or client error, among other possible causes. Rather than query content database 540, cache manager 600 could instead inspect cache 602 and determine that event metadata 610 corresponding to the event does not exist. Origin 550 could then issue response 622 to CDN node 560 indicating that the requested segment could not be found.

In another example, without limitation, suppose origin 550 receives a content request 620 for a segment of audiovisual content having a segment index that is outside of the range of possible segment indices as set forth by stream metadata 612. Similar to the above example, this situation could occur due to encoder defects or client error, among other possible causes. Rather than query content database 540, cache manager 600 could instead inspect cache 602 and determine that the requested segment of audiovisual data cannot exist and therefore is not stored in content database 540. Origin 550 could then issue response 622 to CDN node 560 indicating that the requested segment could not be found.

In yet another example, without limitation, suppose origin 550 receives a content request 620 for a segment of audiovisual content corresponding to a time before encoder 520 generated encoded frames 522 of audiovisual content or corresponding to a time after encoder 520 stopped generating encoded frames 522 of audiovisual content. Similar to the above example, this situation could occur due to encoder defects or client error, among other possible causes. Rather than query content database 540, cache manager 600 could instead inspect cache 602 and determine that the requested segment of audiovisual data cannot exist and therefore is not stored in content database 540. Origin 550 could then issue response 622 to CDN node 560 indicating that the requested segment could not be found.

In yet another example, without limitation, suppose origin 550 receives a content request 620 for a segment of audiovisual content before the scheduled arrival time of that segment of audiovisual content, as set forth by stream metadata 612. This situation could occur due to encoder defects or client error, among other possible causes. Rather than query content database 540, cache manager 600 could instead inspect cache 602 and determine that the requested segment of audiovisual data should not have been received yet and therefore is not stored in content database 540. Origin 550 could then issue response 622 to CDN node 560 indicating that the requested segment has not yet been received.

As a general matter, cache manager 600 can analyze cached metadata stored in cache 602 in order to infer the presence or absence of segments of audiovisual content that may or may not reside in content database 540, thereby greatly reducing the number of requests that need to be handled by content database 540. These techniques are especially useful under conditions where origin 550 needs to respond to large volumes of requests for segments that are missing, unavailable, or otherwise cannot be found within any of CDN nodes 560.

As mentioned above, some media titles may correspond to live events that occur in real time. Accordingly, in various embodiments, origin 550 may receive content requests 620 for segments of audiovisual content associated with the “live edge” of a given media title. In the context of this disclosure, the live edge of a given media title refers to the most recently encoded segment(s) of audiovisual content that are meant to be displayed via endpoint devices 115 as close to the present moment as possible. In some configurations, the network infrastructure 500 implements a “live edge timeout” that defines a maximum allowable staleness for segments of audiovisual content. As a general matter, segments of audiovisual content that fall behind the live edge timeout will not be generated. Via the techniques described herein, cache manager 600 can avoid requesting segments of audiovisual content from content database 540 when the segments fall behind the live edge timeout.

In addition, under some conditions, various components of the network infrastructure 500 may pause and stop delivering frames of audiovisual content. For example, and without limitation, encoder defects could prevent encoders 520 from delivering encoded frames 522. In these situations, origin 550 may receive content requests 620 for segments of audiovisual content that have not been generated yet and therefore correspond to segment indices beyond the live edge. Via the techniques described herein, cache manager 600 can avoid requesting segments of audiovisual content from content database 540 when the segments exceed the live edge and therefore do not yet exist.

In various embodiments, cache manager 600 implements additional processing logic in order to determine whether a requested segment is not available, as set forth below in Expression 1:

Expression 1

```
if (
  requested segment index <= last segment index +
  ceil(caching duration / segment duration
):
  fetch segment
else:
  issue 404 response
```

The processing logic set forth above accounts for situations where the duration that metadata remains stored in cache 602 (i.e. the caching duration) differs from the length of each segment (i.e. the segment duration). According to this logic, cache manager 600 will issue an HTTP 404 response when segments of audiovisual content are requested that either fall behind the live edge timeout and are therefore not available or exceed the live edge and do not yet exist. This approach mitigates asynchronies that arise when portions of the network infrastructure 500 stall or pause during streaming. In one embodiment, when a requested segment falls behind the live edge, origin 550 may issue an HTTP 410 response corresponding to a “gone” status indicating that the requested segment will never be available and should not be requested again.

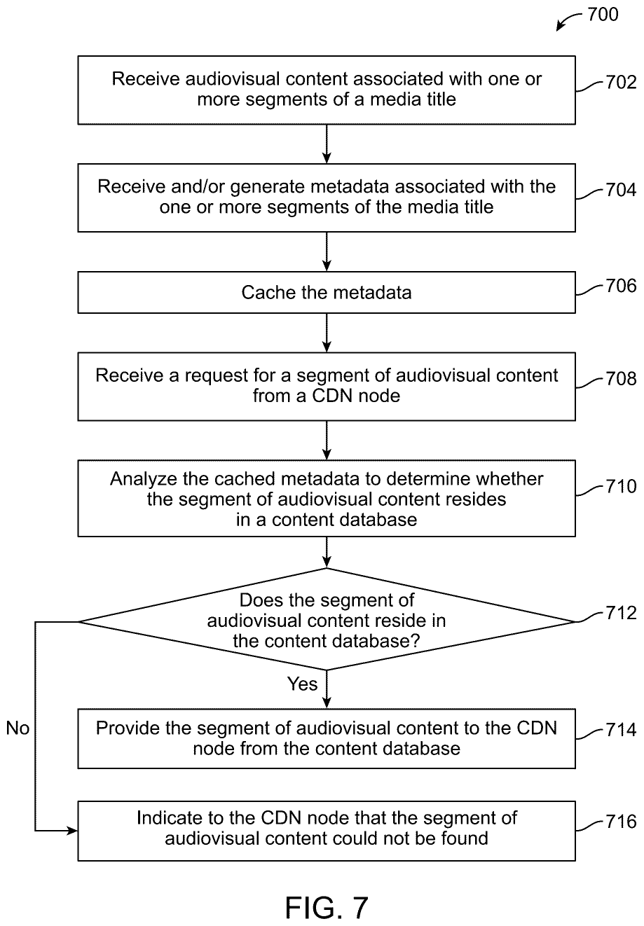

FIG. 7 is a flow diagram of method steps for servicing requests for audiovisual content, according to various embodiments. Although the method steps are described in conjunction with the systems of FIGS. 1-6, persons skilled in the art will understand that any system configured to perform the method steps, in any order, is within the scope of the present invention.

As shown, a method 700 begins at step 702, where the origin 550 receives audiovisual content associated with one or more segments of a media title. A given segment of audiovisual content may correspond to a fixed duration (e.g. two seconds) or a variable duration. The media title may be previously recorded or correspond to a live event occurring in real time.

At step 704, the origin 550 receives, derives, and/or updates metadata associated with the one or more segments of the media title. That metadata includes event metadata 610, stream metadata 612, and segment metadata 614. In various embodiments, origin 550 may generate a new version or update an existing version of stream metadata 612 and/or segment metadata 614 as segments are received from the packagers 530. Event metadata 610 includes timing and/or configuration parameters associated with a given media title. Stream metadata 612 includes timing parameters associated with one or more streams of audiovisual content associated with a given media title. Segment metadata 612 includes per-segment data that generally changes segment to segment.

At step 706, the cache manager 600 within the origin 550 caches the metadata within cache 602. The event metadata 610 and the stream metadata 612 typically change infrequently when streaming a given media title. Therefore, the portions of metadata can be cached and used to identify whether certain segments of audiovisual data are available.

At step 708, the origin 550 receives a content request 620 for a segment of audiovisual content from a CDN node 560. The CDN node 560 responds to requests from endpoint devices 115 and provides segments of audiovisual content to the endpoint devices 115 upon request. However, when a CDN node 560 determines that a given segment of audiovisual content cannot be found, the CDN node 560 may issue an HTTP 404 response for fulfillment by origin 550.

At step 710, the cache manager 600 analyzes the cached metadata to determine whether the requested segment of audiovisual content resides in content database 540. For example, and without limitation, the cache manager 600 could determine that an event associated with a requested segment does not exist, and then conclude that the requested segment of audiovisual data does not reside in the content database 540. In another example, without limitation, the cache manager 600 could determine that the requested segment has a segment index that falls outside of the range of possible segment indices, and then conclude that the requested segment of audiovisual data does not reside in the content database 540.

At step 712, if the cache manager 600 determines that the segment of audiovisual content resides in the content database, then the method 700 proceeds to step 714. At step 714, the origin 550 retrieves the segment of audiovisual content from the content database 540 and then provides the segment of audiovisual content to the CDN node, thereby servicing the content request 620.

Alternatively, if at step 712 the cache manager 600 determines that the segment of audiovisual content does not reside in the content database, then the method 700 proceeds to step 716. At step 716, the origin 550 indicates to the CDN node 562 that the segment of audiovisual content could not be found. In one embodiment, the origin 550 may issue an HTTP 404 response. In another embodiment, the origin 550 may determine that the requested segment falls behind a live edge timeout associated with a media title corresponding to a live event, and then issue an HTTP 410 response indicating that the requested segment of audiovisual content should not be requested again.

In sum, various embodiments include one or more origin servers configured to cache metadata associated with media titles being streamed. The metadata indicates timing information associated with the media title and/or one or more streams of encoded audiovisual content associated with the media title. When a given origin server receives a request for a segment of audiovisual content, before querying a content database to locate the segment, the origin server first inspects a cache and then determines, based on the metadata, whether the requested segment exists and has already been stored in the content database. If the origin server determines that the segment of audiovisual data does in fact reside in the content database, then the origin server fulfills the request. Otherwise, the origin server issues a response indicating that the requested segment is unavailable, without needing to issue any requests to the content database.

At least one technical advantage of the disclosed techniques relative to the prior art is that the origin server can service large volumes of requests for segments of audiovisual content that may not exist within the content database, without needing to issue correspondingly large volumes of requests to the content database. Accordingly, the disclosed techniques can be applied to protect the content database from a potentially overwhelming volume of requests, thereby helping to avoid performance degradations at the origin server. Another technical advantage of the disclosed techniques relative to the prior art is that the disclosed techniques can help mitigate timing asynchronies that can arise when segments of audiovisual content fall outside of a live edge timeout corresponding to a live event. These technical advantages provide one or more technological advancements over prior art approaches.
1. Various embodiments include a computer-implemented method for servicing requests for audiovisual content when streaming media titles, the method comprising receiving a first request for a first segment of audiovisual content associated with a media title, determining that a content database does not store the first segment of audiovisual content based on an inspection of a cache, and generating a first response to the first request indicating that the first segment of audiovisual content is unavailable.
2. The computer-implemented method of clause 1, wherein determining that the content database does not store the first segment of audiovisual content comprises determining that the cache does not store metadata corresponding to the media title.
3. The computer-implemented method of any of clauses 1-2, wherein determining that the content database does not store the first segment of audiovisual content comprises determining that the cache stores a first portion of metadata corresponding to the media title, and determining that the first portion of metadata indicates a starting time for the media title.
4. The computer-implemented method of any of clauses 1-3, wherein determining that the content database does not store the first segment of audiovisual content comprises determining that the cache stores a first portion of metadata corresponding to the media title, and determining that the first portion of metadata indicates an ending time for the media title that has already occurred.
5. The computer-implemented method of any of clauses 1-4, wherein determining that the content database does not store the first segment of audiovisual content comprises determining that the first segment of audiovisual content corresponds to a first time interval that does not overlap with a second time interval corresponding to a live edge associated with the media title.
6. The computer-implemented method of any of clauses 1-5, wherein determining that the content database does not store the first segment of audiovisual content comprises determining that the first segment of audiovisual content corresponds to a first time that exceeds a second time corresponding to a live edge timeout associated with the media title.
7. The computer-implemented method of any of clauses 1-6, wherein the cache stores one or more portions of metadata that indicate timing parameters associated with one or more media titles.
8. The computer-implemented method of any of clauses 1-7, wherein the cache stores one or more portions of metadata that indicate timing parameters associated with one or more streams of encoded audiovisual content included in the media title.
9. The computer-implemented method of any of clauses 1-8, wherein the cache comprises in-memory storage included in an origin server that stores metadata associated with the media title.
10. The computer-implemented method of any of clauses 1-9, wherein the media title corresponds to a live event occurring in real time.
11. Various embodiments include one or more non-transitory computer-readable media including instructions that, when executed by one or more processors, cause the one or more processors to service requests for audiovisual content when streaming media titles by performing the steps of receiving a first request for a first segment of audiovisual content associated with a media title, determining that a content database does not store the first segment of audiovisual content based on an inspection of a cache, and generating a first response to the first request indicating that the first segment of audiovisual content is unavailable.
12. The one or more non-transitory computer-readable media of clause 11, wherein the step of determining that the content database does not store the first segment of audiovisual content comprises determining that the cache does not store metadata corresponding to the media title.
13. The one or more non-transitory computer-readable media of any of clauses 11-12, wherein the step of determining that the content database does not store the first segment of audiovisual content comprises determining that the cache stores a first portion of metadata corresponding to the media title, and determining that the first portion of metadata indicates an arrival time for the first segment of audiovisual content.
14. The one or more non-transitory computer-readable media of any of clauses 11-13, wherein the step of determining that the content database does not store the first segment of audiovisual content comprises determining that the cache stores a first portion of metadata corresponding to the media title, and determining that the first portion of metadata indicates an ending time for the media title that has already occurred.
15. The one or more non-transitory computer-readable media of any of clauses 11-14, wherein the step of determining that the content database does not store the first segment of audiovisual content comprises determining that the first segment of audiovisual content corresponds to a first time interval that does not overlap with a second time interval corresponding to a live edge associated with the media title.
16. The one or more non-transitory computer-readable media of any of clauses 11-15, wherein the step of determining that the content database does not store the first segment of audiovisual content comprises determining that the first segment of audiovisual content corresponds to a first time that exceeds a second time corresponding to a live edge associated with the media title.
17. The one or more non-transitory computer-readable media of any of clauses 11-16, wherein the cache comprises in-memory storage included in an origin server that stores metadata associated with the media title.
18. The one or more non-transitory computer-readable media of any of clauses 11-17, wherein the first response comprises a Hypertext Transfer Protocol 404 response.
19. The one or more non-transitory computer-readable media of any of clauses 11-18, wherein the first response comprises a Hypertext Transfer Protocol 410 response.
20. Various embodiments include a system comprising one or more memories storing instructions, and one or more processors coupled to the one or more memories that, when executing the instructions, perform the steps of receiving a first request for a first segment of audiovisual content associated with a media title, determining that a content database does not store the first segment of audiovisual content based on an inspection of a cache, and generating a first response to the first request indicating that the first segment of audiovisual content is unavailable.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

1. A computer-implemented method for servicing requests for audiovisual content when streaming media titles, the method comprising:
receiving a first request for a first segment of audiovisual content associated with a media title;
determining that a content database does not store the first segment of audiovisual content based on an inspection of a cache; and
transmitting a first response to the first request indicating that the first segment of audiovisual content is unavailable.

2. The computer-implemented method of claim 1, wherein determining that the content database does not store the first segment of audiovisual content comprises determining that the cache does not store metadata corresponding to the media title.

3. The computer-implemented method of claim 1, wherein determining that the content database does not store the first segment of audiovisual content comprises:
determining that the cache stores a first portion of metadata corresponding to the media title; and
determining that the first portion of metadata indicates a starting time for the media title.

4. The computer-implemented method of claim 1, wherein determining that the content database does not store the first segment of audiovisual content comprises:
determining that the cache stores a first portion of metadata corresponding to the media title; and
determining that the first portion of metadata indicates an ending time for the media title that has already occurred.

5. The computer-implemented method of claim 1, wherein determining that the content database does not store the first segment of audiovisual content comprises determining that the first segment of audiovisual content corresponds to a first time interval that does not overlap with a second time interval corresponding to a live edge associated with the media title.

6. The computer-implemented method of claim 1, wherein determining that the content database does not store the first segment of audiovisual content comprises determining that the first segment of audiovisual content corresponds to a first time that exceeds a second time corresponding to a live edge timeout associated with the media title.

7. The computer-implemented method of claim 1, wherein the cache stores one or more portions of metadata that indicate timing parameters associated with one or more media titles.

8. The computer-implemented method of claim 1, wherein the cache stores one or more portions of metadata that indicate timing parameters associated with one or more streams of encoded audiovisual content included in the media title.

9. The computer-implemented method of claim 1, wherein the cache comprises in-memory storage included in an origin server that stores metadata associated with the media title.

10. The computer-implemented method of claim 1, wherein the media title corresponds to a live event occurring in real time.

11. One or more non-transitory computer-readable media including instructions that, when executed by one or more processors, cause the one or more processors to service requests for audiovisual content when streaming media titles by performing the steps of:
receiving a first request for a first segment of audiovisual content associated with a media title;
determining that a content database does not store the first segment of audiovisual content based on an inspection of a cache; and
transmitting a first response to the first request indicating that the first segment of audiovisual content is unavailable.

12. The one or more non-transitory computer-readable media of claim 11, wherein the step of determining that the content database does not store the first segment of audiovisual content comprises determining that the cache does not store metadata corresponding to the media title.

13. The one or more non-transitory computer-readable media of claim 11, wherein the step of determining that the content database does not store the first segment of audiovisual content comprises:
determining that the cache stores a first portion of metadata corresponding to the media title; and
determining that the first portion of metadata indicates an arrival time for the first segment of audiovisual content.

14. The one or more non-transitory computer-readable media of claim 11, wherein the step of determining that the content database does not store the first segment of audiovisual content comprises:
determining that the cache stores a first portion of metadata corresponding to the media title; and
determining that the first portion of metadata indicates an ending time for the media title that has already occurred.

15. The one or more non-transitory computer-readable media of claim 11, wherein the step of determining that the content database does not store the first segment of audiovisual content comprises determining that the first segment of audiovisual content corresponds to a first time interval that does not overlap with a second time interval corresponding to a live edge associated with the media title.

16. The one or more non-transitory computer-readable media of claim 11, wherein the step of determining that the content database does not store the first segment of audiovisual content comprises determining that the first segment of audiovisual content corresponds to a first time that exceeds a second time corresponding to a live edge associated with the media title.

17. The one or more non-transitory computer-readable media of claim 11, wherein the cache comprises in-memory storage included in an origin server that stores metadata associated with the media title.

18. The one or more non-transitory computer-readable media of claim 11, wherein the first response comprises a Hypertext Transfer Protocol 404 response.

19. The one or more non-transitory computer-readable media of claim 11, wherein the first response comprises a Hypertext Transfer Protocol 410 response.

20. A system comprising:
one or more memories storing instructions; and
one or more processors coupled to the one or more memories that, when executing the instructions, perform the steps of:
receiving a first request for a first segment of audiovisual content associated with a media title;
determining that a content database does not store the first segment of audiovisual content based on an inspection of a cache; and
transmitting a first response to the first request indicating that the first segment of audiovisual content is unavailable.
